(19) United States
(12) Patent Application Publication
(10) Pub. No.: US 2018/0197301 A1
(43) Pub. Date: Jul. 12, 2018

(54) SYSTEM AND METHOD FOR DETECTING AND ANALYZING AIRPORT ACTIVITY

(71) Applicant: Derek K. Anderson, Eden Prairie, MN (US)

(72) Inventor: Derek K. Anderson, Eden Prairie, MN (US)

(21) Appl. No.: 15/863,117

(22) Filed: Jan. 5, 2018

Related U.S. Application Data
(60) Provisional application No. 62/443,327, filed on Jan. 6, 2017.

(51) Int. Cl. G06T 7/292; G06T 7/70

(52) U.S. Cl. CPC G06T 7/292; G06K 9/627; G06T 2207/30236; G06T 7/70

(57) ABSTRACT

A system and method for automatically identifying and documenting aircraft and aircraft operations. The system includes image capture device(s) configured to capture images of an operation area that is utilized by aircrafts. The system includes a processing device configured to analyze the captured images to determine characteristics of each aircraft in the operation area.

### FIELD

This disclosure relates to aircrafts and aircraft operations within around an aircraft facility (e.g., an airport, an airfield, etc.).

### BACKGROUND OF THE INVENTION

Aircrafts travel between aircraft facilities such as airports, heliports, sea plane bases, or airfields. An aircraft facility requires documentation of operational metrics including the identification of any aircraft utilizing the aircraft facility. An aircraft facility that includes an aircraft control tower with one or more air traffic controllers or a tracking system may have one or more manual or automated processes to document some operational metrics.

### BRIEF SUMMARY OF THE INVENTION

An automated aircraft tracking system can utilize one or more image capture devices to automatically detect one or more aircrafts in one or more operational areas of an aircraft facility. The automated aircraft tracking system can be configured to determine the operational metrics for each aircraft in the operation area. The automated aircraft tracking system can be configured to automatic and accurately document the identity and operational metrics of each aircraft in the operation area.

In an embodiment, an automated aircraft tracking system includes an operation area that is a designated area for aircrafts to land, takeoff, or land and takeoff from an aircraft facility, an image capture device configured to capture images that include part of an operation area, a processing device, and a storage device. The processing device is configured to analyze the images capture by the image capture device. The storage device is also included to store information, data, or images generated in processing the captured images.

An embodiment of a method for identifying aircraft at an aircraft facility is also described. The method including capturing images of an operation area of the aircraft facility utilizing an image capture device, analyzing the captured images using a processing device and identifying one or more of an aircraft's characteristics, and storing the identified characteristics of the aircraft in a storage device.

### BRIEF DESCRIPTION OF THE DRAWINGS

Both described and other features, aspects, and advantages of au automated aircraft tracking system and methods of automatically tracking an aircraft and will be better understood with reference to the following drawings:

FIG. 1 shows a schematic diagram of an embodiment of an automated aircraft tracking system.

FIG. 2 shows an embodiment of an aircraft operation, which may be detected by an automated tracking system as an aircraft departure.

FIG. 3 shows an embodiment of an aircraft operation, which may be detected by an automated tracking system as an aborted aircraft departure.

FIG. 4 shows an embodiment of an aircraft operation, which may be detected by an automated tracking system as an aborted aircraft departure that occurs before an aircraft leaves the ground.

FIG. 5 shows an embodiment of an aircraft operation, which may be detected by an automated tracking system as aircraft arrival.

FIG. 6 shows an embodiment of an aircraft operation, which may be detected by an automated tracking system as an aborted aircraft arrival.

FIG. 7 shows an embodiment of an aircraft operation, which may be detected by an automated tracking system as an aircraft flyby.

FIG. 8 shows an embodiment of an aircraft operation, which may be detected by an automated tracking system as an aircraft touch-and-go.

FIG. 9 shows an embodiment of an aircraft operation, which may be detected by an automated tracking system as a helicopter or drone departure.

FIG. 10 shows an embodiment of an aircraft operation, which may be detected by an automated tracking system as a helicopter or drone arrival.

FIG. 11a shows an embodiment of an image capture device that captures a single view point.

FIG. 11b shows an embodiment of an image capture device that captures a multiple view points

FIG. 11c shows an embodiment of an image cap device captures a hundred and eighty degree view around the image capture device.

FIG. 11d shows an embodiment of an image capture device that captures a three hundred and sixty degree view around the image capture device.

FIG. 12 shows an embodiment of an automated aircraft tracking system illustrating the possible placements and configurations for image capture devices.

FIG. 13 shows a flow chart of showing an embodiment of a method for identifying an aircraft and aircraft operations.

FIG. 14 shows a flowchart showing an embodiment of a method of identifying aircraft and aircraft operations.

FIG. 15 shows a flowchart showing an embodiment of a method of identifying aircraft and aircraft operations and corresponding structural components that may perform parts of the method.

FIG. 16 shows a schematic diagram of an embodiment of automated aircraft tracking system that locally processes and stores aircraft information.

FIG. 17 shows a schematic diagram of an embodiment of automated aircraft tracking system that locally processes and remotely stores aircraft information.

FIG. 18 shows a schematic diagram of an embodiment of automated aircraft tracking system that locally captures and remotely processes and stores aircraft information.

### DETAILED DESCRIPTION OF THE INVENTION

Aircrafts, which may also be referred to as flying crafts or flying vehicles, are devices or vehicles that allow for air flight. An aircraft may utilize any type of power source (e.g. mechanical engine, jet propulsion, electric engine, etc.) or lift mechanism (e.g., fixed wing mechanism, a spinning rotor mechanism, a propulsion thrust mechanism, etc.) to overcome the force of gravity. An aircraft may be a manned or unmanned. For example, an aircraft can be an airplane, a helicopter, a gyrocopter, a drone, a glider, a rocket, or other flying object.

The aircraft may operate at or between one or more aircraft facilities; an aircraft facility can also be known as an airfield, airport, heliport, or seaplane base. An airport will include areas, defined as operational areas, configured for aircrafts to arrive, depart, or land and depart. The type of operational area used by an aircraft depends upon the type of aircraft and can include any type of area with a surface, also defined as an operational surface, where an aircraft can perform a takeoff or landing. For example, aircrafts typically utilize operational areas with operational surfaces such as paved runways, grass runways, grass fields, or waters runways; an aircraft that can utilizes a substantially horizontal operation (e.g., helicopters, drones, etc.) may also utilize runways, taxiways, or landing pads.

Aircrafts operate around imports using flying patterns based on best practice, governance (e.g. FAA regulations, airport regulations, etc.), and each aircraft's physical features (e.g. list mechanism, shape, weight, etc.). An attempted departure or arrival of an aircraft at an airport, whether aborted or successful, can be defined as an operation. The most common aircraft operations are departures and arrivals, known as takeoffs and landings respectively. An operation can be identified by tracking the positon or motion of an aircraft.

Some airports may be used for additional purposes other than departing and arriving. For example, an airport may be used for aircraft storage, shuttling people or cargo to and from the aircrafts, and repairing aircrafts.

Airports and airfields need operational metrics for planning and funding. The optimal operational metrics will include the total number of operations; the type, category, and classification of the aircraft; the number of aircraft departures and arrivals; and the number of aborted takeoffs and landings. In addition, airports may also want to know the specific type of operation that took place; the type, category, and classification of the aircraft that performed each operation; or the motion of an aircraft between its arrival and departure.

A controlled airport is an airport that has a control tower with air traffic controllers. At controlled airports, the air traffic controllers may document the number of aircrafts and operations at the airport. However, the operational metrics documented by air traffic controllers do not fully record every aspect of the operational metrics (e.g., type, category and classification of aircraft, aborted takeoffs or landings, specific identity or tail number of each aircraft, etc.) and have reduced accuracy due to human error. A variety of factors many determine why an air traffic controller does not fully document the operational metrics; for example, aircraft controllers may not record metrics due to a management or agency policy, inexperience, work load, visibility, an obstructive view, or a combination thereof Some controlled airports also have limited operating hours that reduce the accuracy of the documented operational metrics. Air traffic controllers also cannot rely on radio communications because pilots may use call signs that have no relation to the aircraft's identity or tail number. Transponders, ADS-B, or similar devices are also unreliable because no rule or regulation requires these types of devices to disclose or relate to the aircraft's identity or tail number.

An airport without a control tower, also known as non-towered or non-controlled airports, typically do not document operational metrics. Non-towered airports also do not require an aircraft to use a radio, transponder, or transponder type device (e.g., ADS-B, etc.). Non-controlled airports typically rely on flight base operators or perform short studies to estimate the annual operational metrics. The availability of this “manually” collected or “estimated” operations data, for both controlled and uncontrolled airports, is typically dependent upon the airport's management. The accuracy and quality of this data is highly dependent upon the airport's procedures and can vary greatly between airports. The types of data collected will also depend upon the documentation rules/regulations set by the airport's management and regulatory agencies.

An airport may also collect operational metrics by using sound/noise metering devices or devices that record radio clicks. Sound noise level meters detect for the sound of aircrafts but have issues with false positives due to nearby other sounds registering as an operation, such as an operating lawnmower, taxiing aircraft, or aircraft's run-up. Determining operations by recording aircraft radio clicks has also had issues with false positives. For example, a false positive may occur when radio clicks can be heard from neighboring airports airfields on a common radio frequency or when pilots click multiple times when performing a single operation. For these reasons, these the current methods produce inaccurate operational metrics. These methods also fail to record the aircraft type, aircraft tail number, or the general category or classification of the aircraft.

Embodiments described in this specification may include an airport with an automated aircraft tracking system. The airport with the automated aircraft tracking system can be utilized to automatically collect and document the operational metrics of an aircraft facility, increasing the accuracy and reliability of the documented operational metrics. In one embodiment, the automated aircraft tracking system may include one or more image capture devices to capture images of an operation area. The automated aircraft tracking system may also include a processing device to analyze images and identify, classify, count, and track aircrafts and aircraft operations within the airport. In such an embodiment, the automated aircraft tracking system may include a storage device for storing the information generated by the processing device when analyzing the captured images.

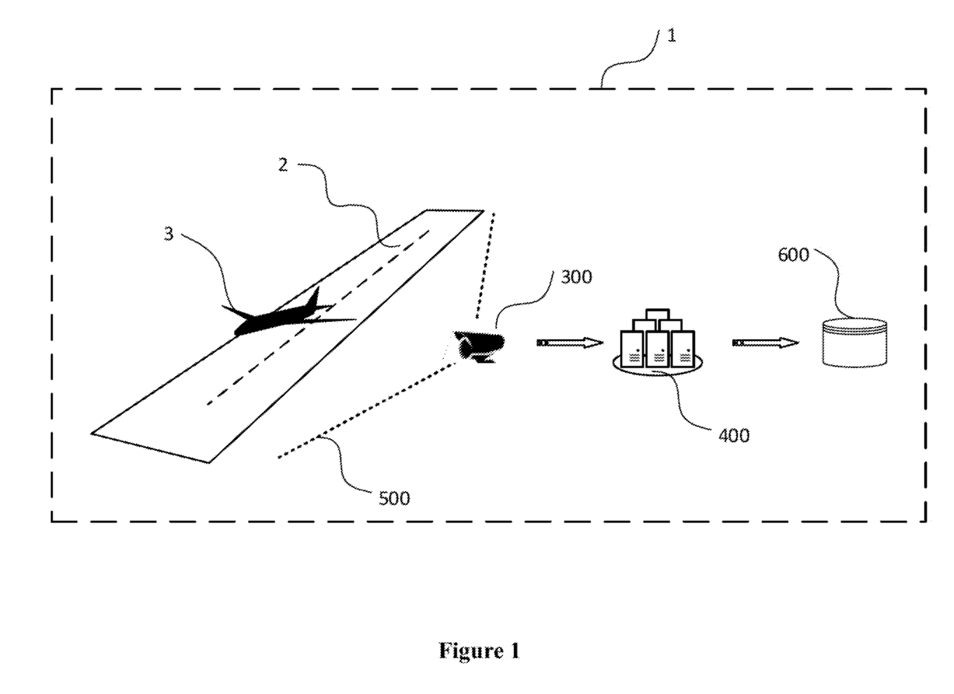

FIG. 1 shows a schematic diagram of an embodiment of an airport operation area 2 including an automated aircraft tracking system 1. The automated aircraft tracking system 1 can include, among other features, an image capture device 300, an image processing device 400, and an aircraft database 600. An aircraft 3, as an example, is shown performing an operation from the runway 2, and an image capture device 300 captures images of the operation area 2. An aircraft 3 is shown performing a takeoff (departure from the airport), but other embodiments may include other types of operations.

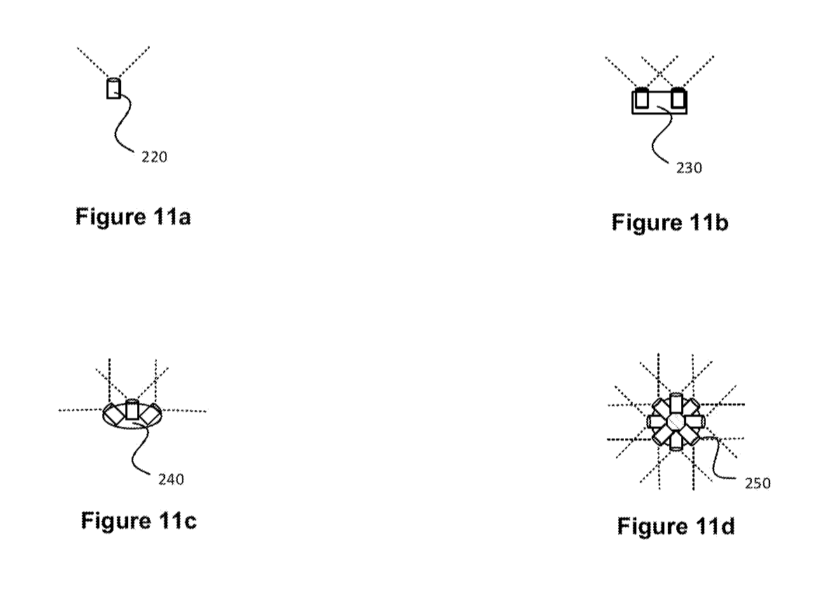

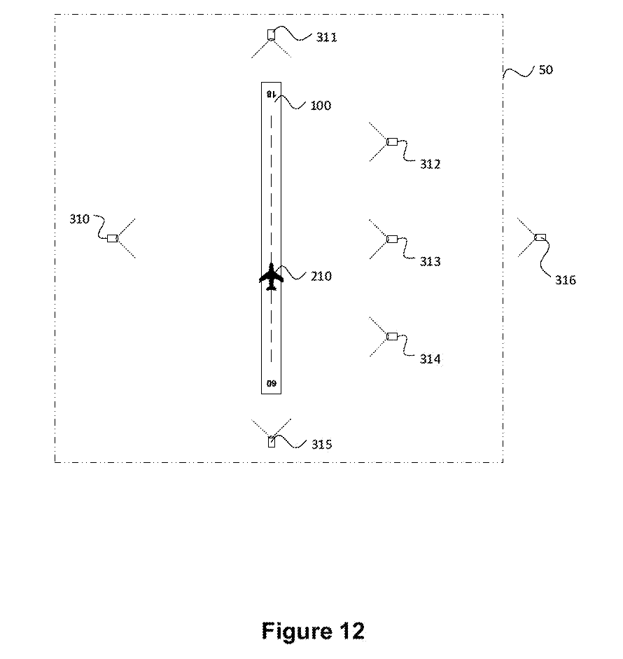

The automated aircraft tracking system 1 utilizes an image capture device 300 to capture images of each any aircraft 3 in the operation area 2. FIG. 1 shows a single operation area 2 with a single paved runway, but other embodiments may include other types of operational surfaces and multiple operation areas. In some embodiments that include multiple operation areas, the operation areas or operational surfaces a runways, landing pads, etc.) may overlap. The image capture device 300 is also shown to include a field of view 500 that includes the entire operation area 2. As later described below with respect to FIGS. 11 and 12, other embodiments may include multiple image capture devices 300, and multiple views of the operational area 2.

The image capture device 300 may include any type of device or system that can create or capture an image serviceable for identifying any aspect of an aircraft's physical characteristics including the aircraft's location and movement. For example; an image capture device 300 may be a type of imaging device that utilizes light in the human visual range or infrared spectrum, thermal imaging, laser of LIDAR imaging, passive radar, acoustic beamforming or acoustic imaging. Some embodiments of an image capture device 300 may produce a 3D map or point grid view. The image of an image capture device 300 may vary in aspect, scale, resolution, definition, quality, and field of capture depending upon the technology being employed, for example, the lens and focal length of a camera. Some embodiments may also include other types of devices that generate supplemental data about the aircraft, for example, a range finder or radar may be employed to help determine an aircraft's movement, identify an aircraft's operation, or determine which image capture device 300 or images are most likely to show the aircraft's trail number, type, classification, and category. The specification describes an image or images, but it should be understood that these descriptions may include any data or image produced by an image capture device 300.

FIG. 1 also depicts an image processing device 400. An embodiment of an image processing device 400 may include a processor (not shown). The image processing device 400 is configured to analyze the images produced by the image capture device 300. The image processing device 400 in some embodiments may include a connection (e.g., a wired electrical connection, a wireless connection, an internet connection, etc.) that allows the images produced by the image capture devices 300 to be sent to the image processing device 400. The image processing device 400 may also include an internet connection for the image processing device 400 to interact with online databases or other sources. There is no required location for the processing device 300; for example, the processing device may be located within the airport property, at a separate location utilized by the airport, or a cloud based computing process.

Some embodiments of an automated aircraft tracking system 1 may include one or more electronic storage devices (not shown) for storing images or data. One or more storage devices may be located in the image capture device 300, the image processing device 400, or other location accessible by the processing device 400 or image capture device 300 (e.g., on-site server, cloud-based server, etc.). Other embodiments may have no connection between the image capture device 300 and the processing device 400, but include each image capture device 300 connected to one or more storage devices that allow for later analysis of the stored images. In such an embodiment the processing device 400 may be at a separate location (e.g., off-site server, third party facility, etc.).

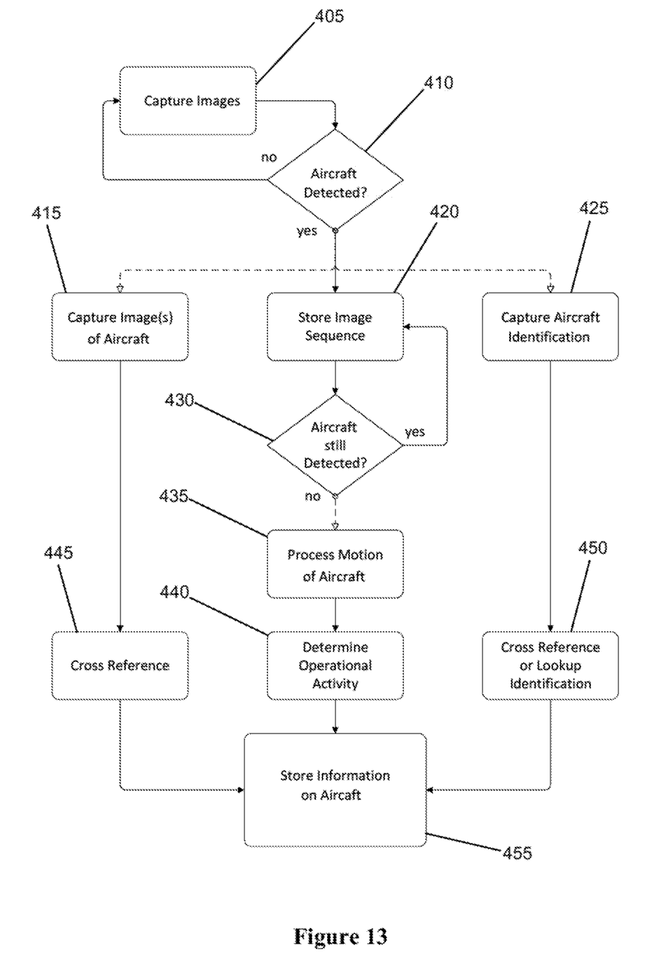

Other embodiments may configure the image capture device 300 to include a processor for processing images for analysis or storage. The processing device 400 may then analyze the images stored in the electronic storage device. Depending on the specific embodiment, the processing and analysis of images may occur differently. An embodiment may utilize real-time processing that is configured to continuously analyze the capture images and only store resulting data or images. Some embodiments may have all the captured images put on a storage device for later analysis. Other embodiments may continuously process images and store only the images found relevant for analysis; the stored images would then be analyzed at a later time. FIG. 13 (described below) demonstrates one possible embodiment of how a processing device 400 may analyze an image.

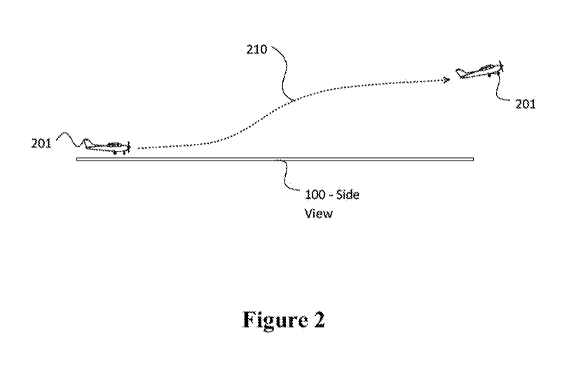

FIGS. 2-10 show embodiments of different aircraft movements, which may be detected by an automated aircraft tracking system as different types of operations. These operations are not intended to be a complete set of operations, operational patterns, or aircraft movements but exemplify the common flight patterns performed during an operation. FIGS. 2-8 show embodiments of an aircraft 201 while utilizing a runway 100. FIGS. 2-8 show the operations from a side view, which is a view perpendicular to the aircraft's direction of travel. FIGS. 2-8 show the aircraft 201 as an airplane, but other embodiments may utilize other types of aircrafts in similar operational patterns. Other embodiments may also include different types or shaped operational areas then the straight runway 100 shown in FIGS. 2-10.

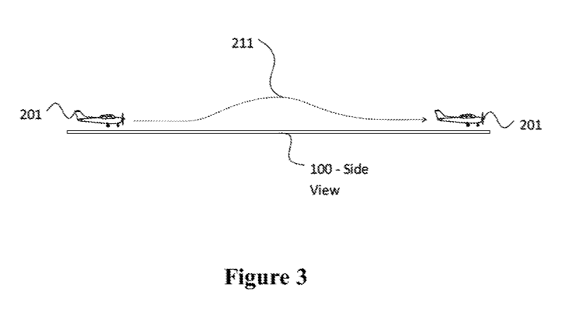

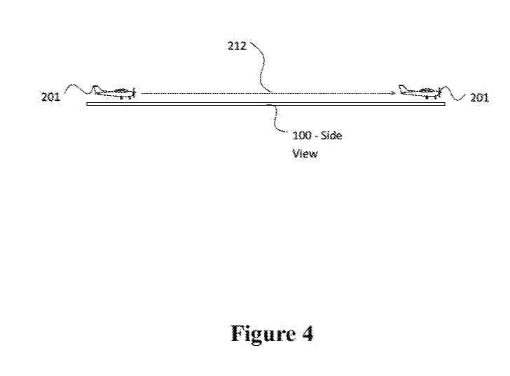

FIG. 2 shows the movement of an aircraft 201 that would be detected as a takeoff 210. During the takeoff 210, the aircraft 201 accelerates down the runway 100 and takes flights. FIG. 3 shows the movement aircraft 201 that would be detected as an aborted takeoff 211, during which the aircraft 201 accelerates down the runway 100 and takes flight, aborts the takeoff while in the air and returns to the runway 100, and then decelerates. FIG. 4 shows the movement of an aircraft 201 that would be detected as an aborted takeoff 212, during which the airplane 201 accelerates down the runway 100 as it attempts a takeoff, aborts the takeoff prior to leaving the runway 100, and then decelerates.

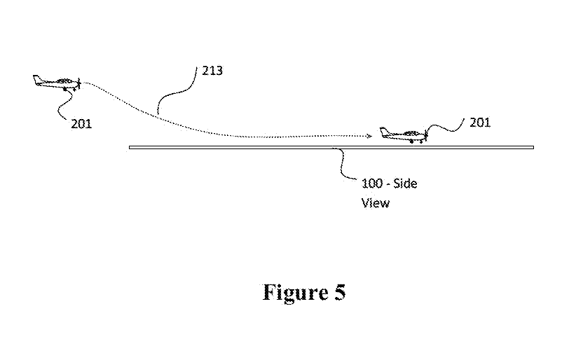

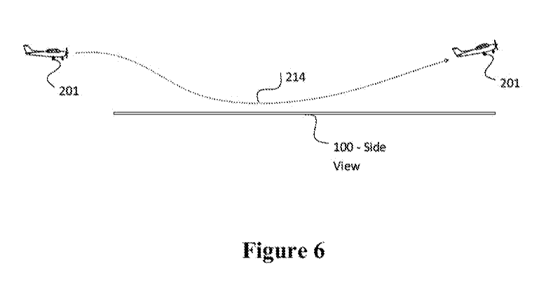

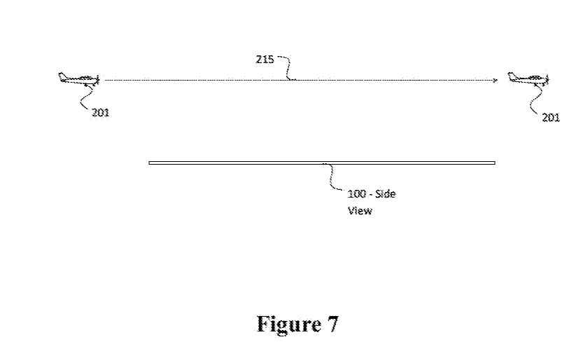

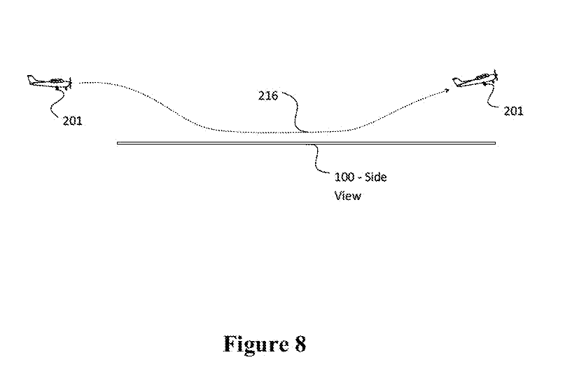

FIG. 5 shows the movement of an aircraft 201 that would be detected as a landing 213. During a landing 213, the aircraft 201 will descend until it lands on the runway 100 and then it will decelerate. FIG. 6 shows the movement of an aircraft 201 that would be detected as an aborted aircraft landing 214, also known as a go-around. During a go-around 214 the aircraft 201 attempts to make a landing, but due to some factor (e.g., obstacle, wind, etc.) the aircraft 201 is aborts the landing, accelerates, and continues its flight. FIG. 7 shows the movement of an aircraft 201 that would be detected as a flyby 215, during which an aircraft 201 remains in flight and continues at generally constant speed above the runway 100. FIG. 8 shows the movement of an aircraft 201 that would be detected as a touch-and-go 216, during which an aircraft 201 descends until the aircraft 201 lands on the runway 100. remains in motion on the runway 100, then accelerates and takes flight.

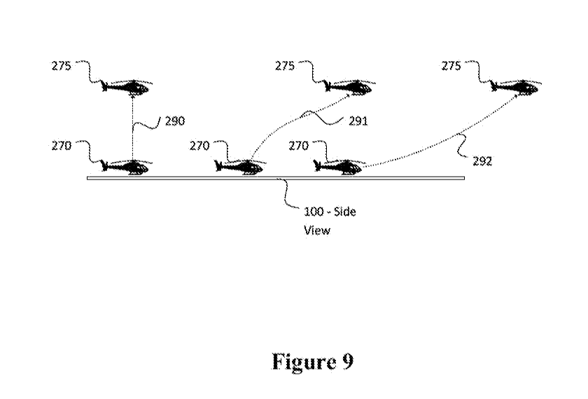

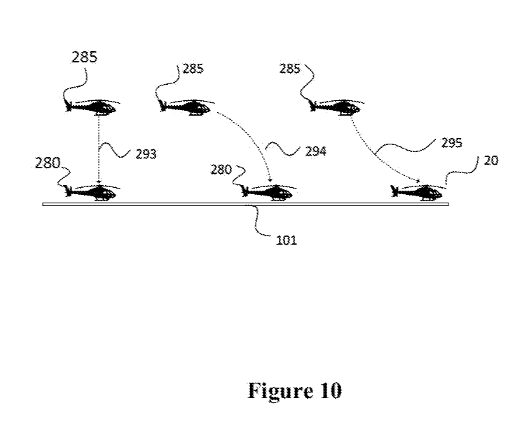

FIGS. 9 and 10 show embodiments of different aircraft (e.g., helicopter, drone, etc.) movements, which may be detected by an automated aircraft tracking system as an aircraft departing from or arriving at a runway 100. A runway 100 is shown here, but other embodiments may include a different types or shaped operation areas, such as those previously described. FIG. 9 shows the movement 290 of a departing aircraft 270 that vertically ascends to a flight position 275 above the runway 100 that would be detected as a vertical takeoff. FIG. 9 also shows the movements 291, 292 of a departing aircrafts 270 that would he detected as a forward ascent takeoff FIG. 10 shows the movement of aircrafts 293, 294, 295 that would be detected as an aircraft landing. An arriving aircraft 285 may be detected as utilizes a vertical landing 293 or forward descent landing 294, 295.

Each individual image capture device may capture multiple views. FIGS. 11a -11d shows embodiments of an image capture device (or devices) configured to produce multiple viewpoints. Some embodiments may include multiple individual devices, while others may include multiple image receivers (e.g., multiple camera lenses, receiving antenna, etc.). FIG. 11b shows an embodiment of an image capture device 230 that captures multiple views. FIG. 11c shows an embodiment of an image capture device 240 that captures a field of view that is hundred and eighty (horizontal) degrees around the image capture device 240. FIG. 11d shows an embodiment of an image capture device 250 that captures in all horizontal directions (i.e. three hundred and sixty degrees) around the image capture device 250. Some embodiments of an image capture device may be positioned or vertically angled as required to adequately capture images of an operation area that allow for the identification of each aircraft and operation within the operation area. Embodiments are not limited to a specific viewing angle (e.g., one hundred and eighty degrees, three hundred and sixty degrees, etc.).

Some embodiments may configure one or more image capture devices 220 for capturing images for a specific imaging method, such as stereo vision for depth perception. Furthermore, one or more image capturing devices may he employed to produce one hundred and eighty degree or three hundred and sixty degree stereo vision, also known as virtual reality (VR).

An overhead, downward view of one embodiment of an airport is shown in FIG. 12. One or more image capture devices 310-316 may be placed in various locations around an airport to provide a view of a part or all of the operation area 100. An embodiment may capture images of the operation area 100 in a single view, a continuous view, or both. FIG. 12 shows an embodiment employing both views. The image capture device 310 shows a single view, wherein the image capture device 310 has a field of view that captures the entire operation area 100. The image capture devices 312-314 illustrate a continuous view, wherein the field of view of a single image capture device 312, 313, 314 does not capture the entire operation area 100. In a continuous view, the images captured by the capture, devices 312-314 are aggregated to capture a continuous view of an operation area 100. Other embodiments may include two or more image capture devices in a continuous view.

In some embodiments one or more image capture devices may be configured to capture only part of the operation area 100; for example, an embodiment may configure image capture devices to include views for only a part of the operation area 100 if an operation area 100 includes parts that are unlikely to be used for operations. The image capture devices shown only capture images of a single operation area 100, but other embodiments rimy configure an image capture device to capture multiple operation areas.

Image capture devices 311, 315 may be placed at the ends of the operation area 100 to provide different or opposing perspectives of the aircraft 210. An image capture device 316 may also be placed outside an airport parameter 50. The configuration of one or more image capturing devices will depend upon the conditions and structure of a given airport and operation area 100. For example, an embodiment may include multiple types of image capture devices, but employ only specific individual image capture devices during the day, night, or bad environmental conditions (e.g., fog, snow, rain, etc.); an embodiment may also employ multiple types of image capture devices in combination to better identify operations or aircrafts.

An embodiment may also include additional image capture devices (of a similar or different type) to capture different views of an aircraft 210 within the operation area 100. Additional views of an aircraft 210 can provide additional or supplemental information about the aircraft 210. For example, multiple views of an aircraft can provide additional details of the aircraft 210 and may provide a depth prospective that improves the identification of an aircraft's specific location or movement pattern. Each airport may have different conditions that require one or more image capture devices to be utilized individually (e.g., a single view, etc.), as a grouping of similar devices, as a grouping of dissimilar image devices, or as a combination thereof to gather images as required to produce the desired operational metrics.

FIG. 13 shows a flowchart showing an embodiment of a method for identifying aircraft and aircraft operations. Starting at 405, the method starts by having one or more image capture devices continuously capturing images of an operation area.

The images produced are then analyzed at 410 to detect if an aircraft exists in the images. If no aircraft is detected within an image, then no further analysis is undertaken; if an aircraft is detected, the process proceeds to steps 415, 420, and 425. Some embodiments may discard images when no aircraft detected, others may keep these images; for example, some embodiments may keep images to insure the images are available if a false negative occurs.

In embodiments including multiple image capture devices, the analysis for detecting an aircraft 410, or other steps, may then include recognizing that images produced by other views (from other image capture devices) involve the same aircraft. As such, an embodiment may group or label these images of the same aircraft from different views.

The “detection” of an aircraft is also described, it should be understood that this typically means that the image contains all or part of an aircraft, but some embodiments may set specific parameters for when an aircraft should be “detected”. For example, an embodiment may only want to “detect” an aircraft during if the aircraft is performing an operation, thus a view that produces images including areas outside the operation area, may configure an analysis to not consider such non-operation areas in the image, such that an aircraft in a non-operation area of an image is not “detected”.

At steps 420, 430, 435 and 440 the automated aircraft tracking system determines the operational activity of an aircraft. At 420, when an aircraft has been detected, the images are stored for further analysis; once stored, the process proceeds to step 430, where it continuously analyses images to determine if the aircraft is detected in later (in time) images. The process may keep storing images of the aircraft until it is no longer detects the aircraft in later images. Once the aircraft is no longer detected, the analysis will proceed to step 435.

At step 435, the stored images of an aircraft will then be analyzed to determine the motion of the aircraft. The level of detail produced regarding each aircraft's motion will depend upon complexity of a particular embodiment (e.g., the number and types of image capture devices in an embodiment, resolution of images captured, etc.). As described above for FIG. 12, one or more image capture devices may be used together to better determine an aircraft's movement. In most embodiments, the more types and numbers of image capture devices utilized will allow for a better determination of an aircraft's motion.

Additionally or alternatively, the position of an aircraft may be determined by proportional scaling. In proportional scaling, the size of an aircraft as shown in an image is compared to other reference objects (e.g. a specific runway, operation area, etc.) in the image and having known size. The three dimensional position of an aircraft can then be determined using the reference object, the aircraft's known shape (e.g., wing length, etc.), and the viewing angle and position of the image capturing device. An embodiment may also utilize the frame capture rate of an image capture device and multiple images in said proportional scaling to determine the speed and altitude of an aircraft.

Once the motion of an aircraft has been determined, the aircraft's motion will be analyzed for any operations, as shown in step 440. In 440 the motion of an aircraft is analyzed to determine if the aircraft has performed any individual operations. Different embodiments may employ one or more methods of analysis to determine if an aircraft has performed an operation. For example, an operation may be detected by comparing the motion of an aircraft to known motions for operations or an operation may be detected when the aircraft's motion meets specific parameters (e.g., aircraft speed, change in aircraft speed, distance of the aircraft from the ground, etc.). Additionally or alternatively, an embodiment may use machine learning or artificial intelligence to self-learn, describe, and identify the operation type.

Shown at 425, once an aircraft has been detected, the automated aircraft tracking system may also identify the aircraft. An aircraft's identity may be found by analyzing the physical characteristics of an aircraft. An embodiment may focus on specific parts of an aircraft for its identification; for example, the system may analyze images of an aircraft's outside surface including its shape, identifiers, markings, tail number, and registered tail number. Shown at 450, some embodiments may cross reference these physical characteristics with other sources to determine the type, category, and classification of the aircraft. Some embodiments may also include the recording of radio communications, including radio clicks, of transponder data to aid in identifying the aircraft.

Some embodiments may also include devices to record the radio communication of aircrafts or aircraft pilots, transponder signal of aircrafts in the area, or both. The communications or signals may then be analyzed or documented, and included in the data identifying the aircraft.

The automated aircraft tracking system may also use captured specific images of an aircraft. At 415, the system may select images of the aircraft for referencing the aircraft. Additionally, some embodiments may combine the images from one or more image capture devices in a time sequence to provide a video (e.g., animation, movie, clip, segment, time-slice, etc.) of the aircraft. This process may be included in 415, or it may be included in other steps. The captured images or video of an aircraft may then be cross referenced with other sources or stored for later referencing as shown at 445.

After the automated aircraft tracking system has determined the operational activity 440, selected and referenced images, video, or images and video of an aircraft 445, and identified 450 the aircraft, this information may be collectively stored 455 for easy reference of the aircraft. For example, the information stored 455 in an embodiment may include the operations, activity, motion, videos, class, images, and corresponding dates and times for these items. The system may only store information relevant to documenting. operational metrics, or it may include all information and images relevant to an aircraft.

Some embodiments may order the different types of image analysis differently; for example, the analysis for determining an aircraft's operation activity (420, 430, 435, 440), the identification of an aircraft (425, 450), and the selecting images, videos, or images and videos of an aircraft (415, 445) may be done sequentially or simultaneously. Other embodiments may also include the collection and storage of image sequences of an aircraft (420, 430) as part of or a proceeding step of identifying an aircraft (425, 450) and selecting images, videos, or images and videos of the aircraft (415, 445). The steps described may occur immediately following a previous step, after a delay between the steps, or in a combination thereof.

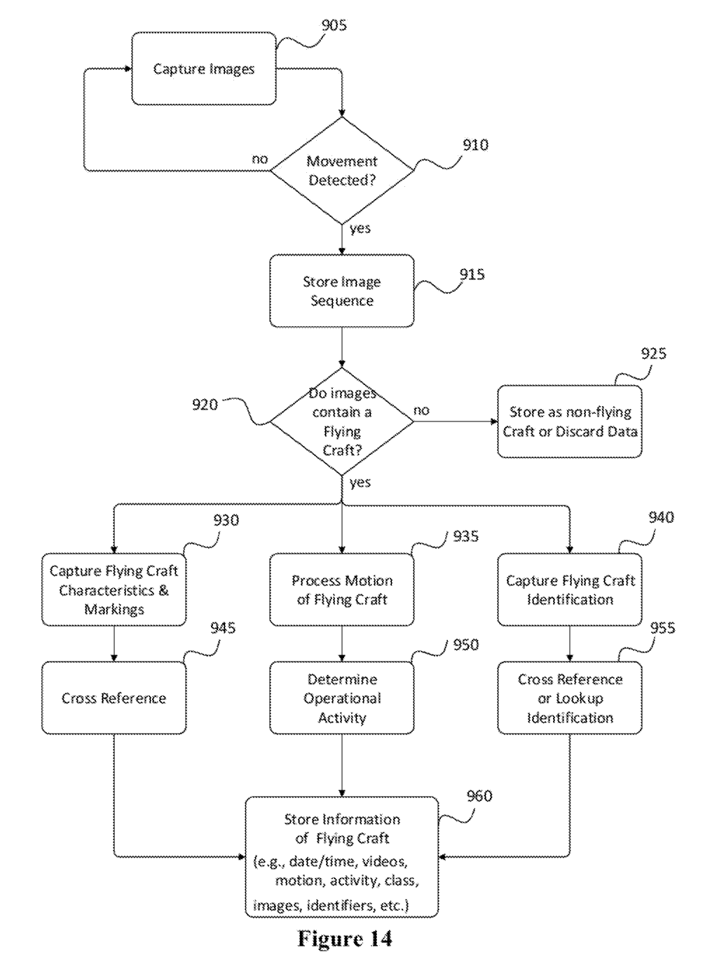

FIG. 14 shows a flowchart showing an embodiment of a method of identifying aircraft and aircraft operations. Starting at 905, the method starts by having one or more image capture devices continuously capturing images of an operation area. At 910 the images are then analyzed for movement or the images are synchronized with a movement capturing device. If movement is detected then the images are stored as shown by 915. Once the images are stored, they can then be analyzed to determine if they contain a flying craft. If no aircraft is detected and depending upon the specific embodiment, the images can be stored as non-flying craft data or be discarded as shown at 925. If an aircraft is detected, then the image can be further analyzed. This analysis may include determining an aircraft's operational activity (as shown by 935 and 950), the identification of the aircraft (as shown by 930 and 945) and the selecting of images, video, or images and video of the aircraft (as shown by 940 and 955). This analysis may include one or more of these types of analysis. The results of each analysis, optionally including any images used in the analysis, may then be stored as shown by step 960. The analysis described may be similar to the analysis described above regarding FIG. 13.

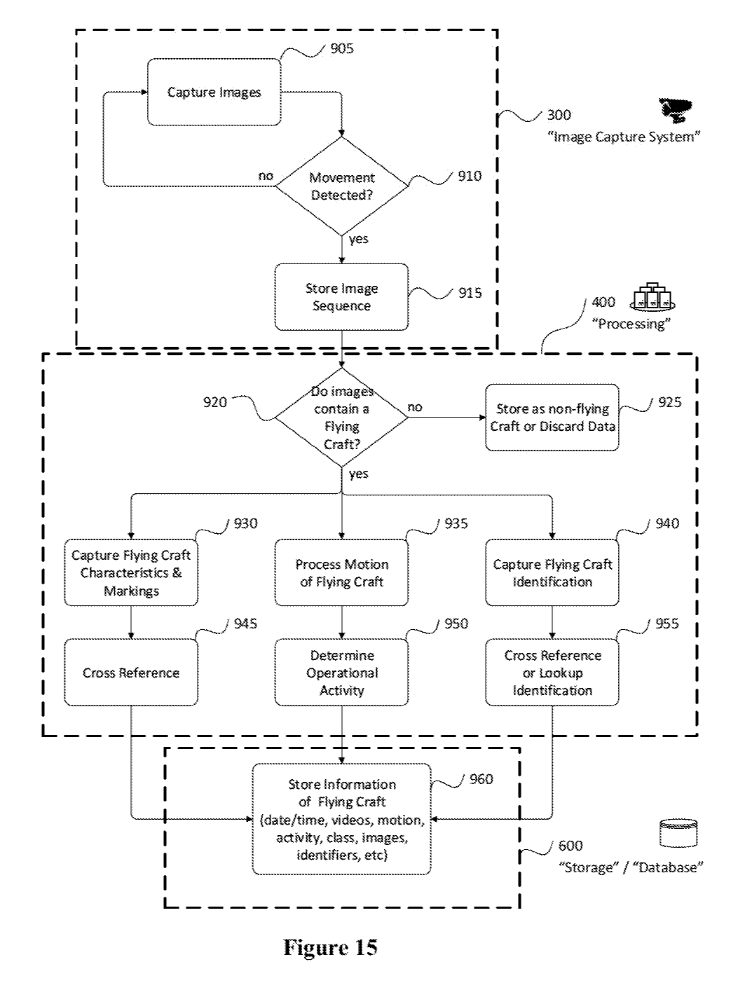

FIG. 15 shows a flowchart showing embodiment of a method of identifying aircraft and aircraft operations and corresponding structural components that may perform parts of the method. In addition to the elements described above for FIG. 14, FIG. 15 shows the structural components that may perform the described elements of the method. For example, an image capture system including one or more image capturing devices 300 may capture and store images, a processing device 400 may perform an analysis of the images, and storage data base 600 that stores any required or desired information, images, and data regarding an aircraft.

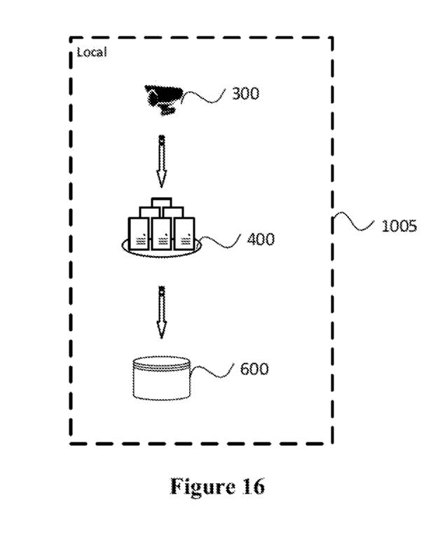

FIGS. 16-18 show schematic diagrams of embodiments for where an automated aircraft tracking system 1 may process captured images. FIG. 16 shows a schematic diagram of an embodiment of automated aircraft tracking system 1 that locally processes and stores aircraft information. In an embodiment the image capture, image processing, and the storage of any desired aircraft information occurs at a local location 1005. The local location 1005 may be near or at the image capture device 300, operational area, aircraft facility, or combination thereof. For example, an embodiment of an aircraft tracking system may use an image processing device 400 at the airport or other location close to the airport to process the image, and then have a storage data base 600 at the airport of other location near the airport. The desired information may include information resulting from processing image or images; images of the aircraft; other information, data, or images described above; or a combination thereof.

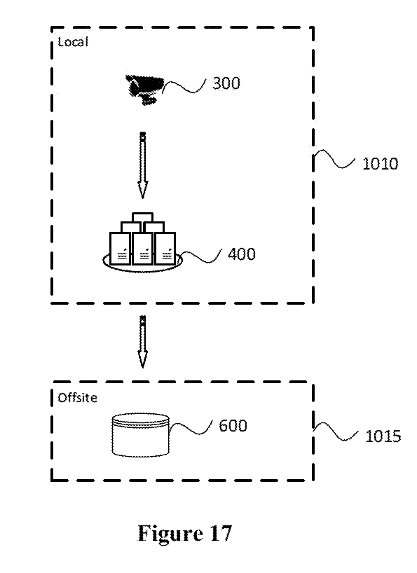

FIG. 17 shows a schematic diagram of an embodiment of automated aircraft tracking system 1 that locally processes and remotely stores aircraft information. In such an embodiment, captured images are processed at a local location 1010 and then the desired aircraft information is stored at a remote location 1015. For example, an embodiment may include an image processing device 400 for processing images at an airport or at a location near the airport and a storage data base 600 at a remote storage that is not local to the aircraft facility. Depending upon the embodiment, the remote storage may be a private storage, public storage, cloud storage, custom storage, or combination thereof. Some embodiments may include transient or temporary storage at a local location that is used until the desired aircraft information reaches the remote storage location.

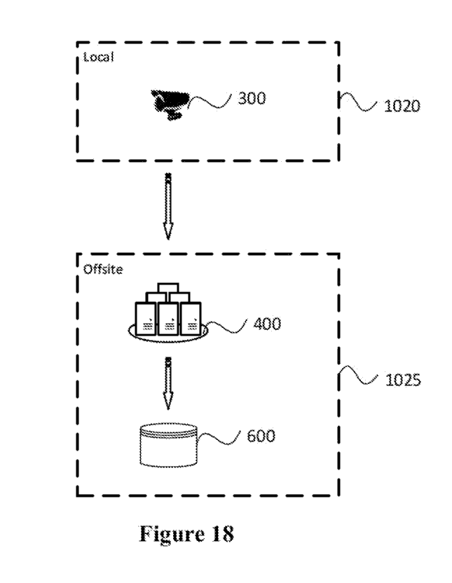

FIG. 18 shows a schematic diagram of an embodiment of automated aircraft tracking system 1 that locally captures and remotely processes and stores aircraft information. In this embodiment all the captured images are sent to a remote location 1025 that processes the images and then stores the desired aircraft information. For example, one or more images captured by an image capture device 300 may be sent to a remote location 1025 that includes an image processing device 400 to process the images and storage data base 600 to remotely store data. In some embodiments, the images captured by the image capture devices 300 are sent to a remote location 1025 as a live stream of data. Depending upon the embodiment, the remote storage data base 600 may be at a separate remote location from the image processing location. Some embodiments may include transient or temporary storage at a local location 1020 that is used to storage images until they reach a remote location 1025. Some embodiments may also include detecting if movement occurs in an image locally, and sending only those images including movement to a remote location 1025 for full processing of the image and storage of any desired aircraft information. The description for the embodiments shown in FIGS. 16-18 describe includes a remote location, but some embodiments may employ multiple remote locations for storing images, processing images, storing information, or a combination thereof.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. An automated aircraft tracking system for identifying an aircraft, comprising:
an operation area, the operation area being an area utilized by aircrafts to land, takeoff or land and takeoff:
one or more image capture devices configured to capture images that include part or all of the operation area;
a processing device configured to analyze the captured images to determine one or more physical characteristics of each aircraft in the operation area; and
a storage device that stores data generated by the processing device, the data including aircraft information, images generated by the processing, device, images selected by the processing device, or a combination thereof.

2. The aircraft tracking system of claim 1, wherein two or more additional image capture devices capture images of different views of an operation area.

3. The aircraft tracking system of claim 2, wherein multiple image capture devices are positioned to capture only parts of the operation area, such that a processing device can be further configured to generate a continuous view of an aircraft by combining two or more time synchronized images captured by the image capture devices.

4. The aircraft tracking system of claim 1, wherein the processing device can analyze the captured images to identify the motion of an aircraft.

5. The aircraft tracking system of claim 1, wherein the processing device can analyze the captured images to determine if an aircraft has performed an operation.

6. The aircraft tracking system of claim 1, wherein the physical characteristics includes one or more of an aircraft's shape, motion, size, markings, aircraft identifiers, tail number, or registered tail number.

7. The aircraft tracking system of claim 1, wherein the processing device identifies the type, category, and classification of the aircraft by comparing one or more physical characteristics of an aircraft to a source of known aircraft classes and types.

8. The aircraft tracking, system of claim 1, further comprising:
a second storage device configured to store images captured by the image capture device before the images are analyzed by the processing device.

9. The aircraft tracking system of claim 1, wherein the processing device is further configured to detect an accident, crash, or incursion within the operation area.

10. The aircraft tracking system of claim 9, further comprising:
A notification device configured to automatically notifies one or more personal, systems, emergency services, agencies, or combination thereof when the accident, crash, or incursion has been detected.

11. The aircraft identification system of claim 1, wherein the images captured by an image capture device are automatically stored on the storage device.

12. A method of identifying aircraft, comprising:
capturing images of an operation area, the operation area including an area where aircrafts land, takeoff, or land and takeoff:
analyzing the captured images using a processing device, the processing device configured to identify one or more physical characteristics of an aircraft in the operation area; and
storing the identified characteristics of the aircraft in a storage device.

13. The method of claim 12, wherein the physical characteristics of an aircraft include the motion of the aircraft.

14. The method of claim 13, further comprising:
the processing device determining if the aircraft has performed an operation by analyzing, the motion of the aircraft.

15. The method of claim 12, wherein the identified physical characteristics of the aircraft includes one or more of the aircraft's shape, size, markings, aircraft identifiers, tail number, or registered tail number.

16. The method of claim 12, further comprising:
combining two or more captured images of an aircraft to produce a continuous view of the aircraft.

17. The method of claim 12, further comprising:
the processing device determining the aircraft's type, category, and classification by comparing one or more identified physical characteristics of the aircraft to a source of known aircraft classes and types.
